(19) United States
(12) Patent Application Publication
(10) Pub. No.: US 2021/0386533 A1
(43) Pub. Date: Dec. 16, 2021

(54) Disposable Smart Electronic Teeth Cleaning Device

(71) Applicant: AI Biomaterial Healthtech Ltd., Kwun Tong KLN (HK)

(72) Inventor: Yen-Yi Ho, Taoyuan City (TW)

(21) Appl. No.: 16/986,409

(22) Filed: Aug. 6, 2020

(30) Foreign Application Priority Data
Jun. 11, 2020 (TW) 109119703

(51) Int. Cl. A61C 17/02; B08B 7/02; B08B 3/04; B08B 7/04

(52) U.S. Cl. CPC A61C 17/0211; B08B 7/04; B08B 3/04; B08B 7/02

(57) ABSTRACT

A disposable smart electronic teeth cleaning device for cleaning a plurality of teeth is provided. The disposable smart electronic teeth cleaning device includes a liquid pump, a pipe and an U-shaped main body. The liquid pump provides a cleaning liquid. The pipe is in communication with the liquid pump. The U-shaped main body includes a teeth-containing groove and a liquid inlet. The teeth-containing groove contains the plurality of teeth. The liquid inlet is disposed at the teeth-containing groove and is in communication with the pipe. The cleaning liquid provided by the liquid pump flows into the teeth-containing groove via the pipe and the liquid inlet to clean the plurality of teeth in the teeth-containing groove.

### BACKGROUND OF THE INVENTION

### Field of the Invention

The present disclosure relates to disposable smart electronic teeth cleaning devices and, more particularly, to a disposable smart electronic teeth cleaning device whereby caretakers clean clients' teeth conveniently.

### Description of the Prior Art

Some of the elderly in nursing homes are disabled and confined to bed. These persons are unable to hold toothbrushes and brush teeth independently. Therefore, caretakers have to clean these persons' teeth and oral cavities with wet towels.

However, the elderly are likely to gag and unconsciously bite the wet towels while their teeth and oral cavities are being cleaned with the wet towels by the caretakers. Therefore, the caretakers' hands are likely to be bitten by clients while at work. Furthermore, it takes the caretakers much time cleaning clients' teeth and oral cavities. Therefore, it is necessary to provide a teeth cleaning device to address the aforesaid issue.

### SUMMARY OF THE INVENTION

It is an objective of the present disclosure to provide a disposable smart electronic teeth cleaning device whereby caretakers clean clients' teeth conveniently.

In order to achieve the above and other objectives, the present disclosure provides a disposable smart electronic teeth cleaning device for cleaning a plurality of teeth. The disposable smart electronic teeth cleaning device includes a liquid pump, a pipe and an U-shaped main body. The liquid pump provides a cleaning liquid. The pipe is in communication with the liquid pump. The U-shaped main body includes a teeth-containing groove and a liquid inlet. The teeth-containing groove contains the plurality of teeth. The liquid inlet is disposed at the teeth-containing groove and is in communication with the pipe. The cleaning liquid provided by the liquid pump is introduced into the teeth-containing groove via the pipe and liquid inlet to clean the plurality of teeth in the teeth-containing groove.

According to an embodiment of the present disclosure, the disposable smart electronic teeth cleaning device further includes a vibrating element, and the vibrating element is connected to the U-shaped main body.

According to an embodiment of the present disclosure, the teeth-containing groove is U-shaped, and the liquid inlet is disposed at one end of the teeth-containing groove.

According to an embodiment of the present disclosure, the U-shaped main body further includes a liquid outlet, and the liquid outlet is disposed at the other end of the teeth-containing groove and opposite the liquid inlet.

According to an embodiment of the present disclosure, the pipe is made of biodegradable plastic.

According to an embodiment of the present disclosure, the U-shaped main body is made of biodegradable plastic.

### BRIEF DESCRIPTION OF THE DRAWINGS

FIG. 1 is a schematic view of a disposable smart electronic teeth cleaning device according to an embodiment of the present disclosure.

FIG. 2 is a schematic view of the disposable smart electronic teeth cleaning device fitted to teeth according to an embodiment of the present disclosure.

FIG. 3 is a cross-sectional view of the disposable smart electronic teeth cleaning device fitted to the teeth according to an embodiment of the present disclosure.

### DETAILED DESCRIPTION OF THE EMBODIMENTS

The implementation of the present disclosure is illustrated by preferred, specific embodiments to enable persons skilled in the art to easily understand the other advantages and effects of the present disclosure by referring to the disclosure contained therein.

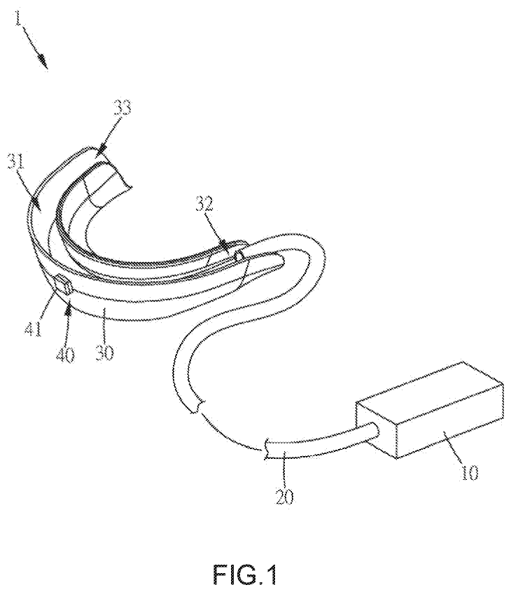

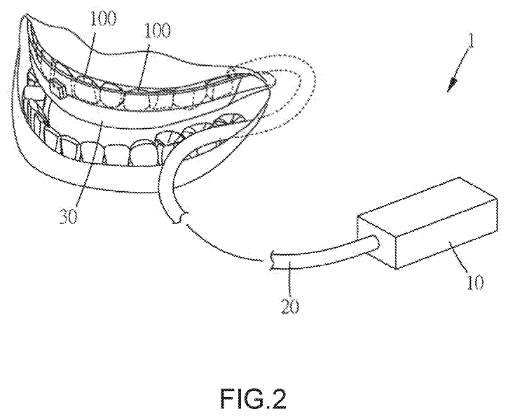

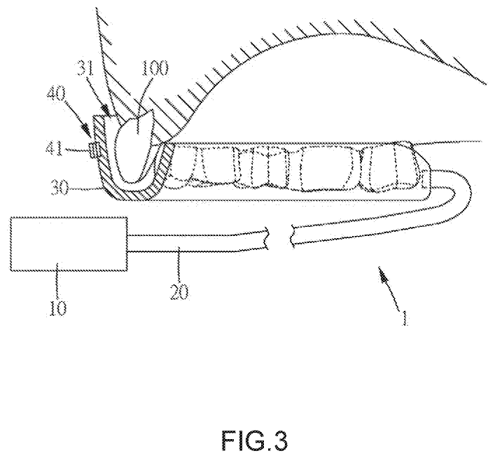

Referring to FIG. 1 through FIG. 3, a disposable smart electronic teeth cleaning device is provided in an embodiment of the present disclosure. FIG. 1 is a schematic view of a disposable smart electronic teeth cleaning device according to an embodiment of the present disclosure. FIG. 2 is a schematic view of the disposable smart electronic teeth cleaning device fitted to teeth according to an embodiment of the present disclosure. FIG. 3 is a cross-sectional view of the disposable smart electronic teeth cleaning device fitted to the teeth according to an embodiment of the present disclosure.

As shown in FIG. 1 through FIG. 3, in an embodiment of the present disclosure, a disposable smart electronic teeth cleaning device 1 is for use by caretakers in cleaning a plurality of teeth 100 of each client safely and easily, especially the teeth 100 of the elderly staying at long-term care facilities in an aging society and being unable to clean teeth independently. The disposable smart electronic teeth cleaning device 1 reduces the incidence of periodontitis, gingivitis, endocarditis and dementia, which can be caused by poor oral hygiene. The disposable smart electronic teeth cleaning device 1 includes a liquid pump 10, a pipe 20, an U-shaped main body 30 and a vibrating element 40.

In an embodiment of the present disclosure, the liquid pump 10 provides a cleaning liquid, such as clean water. The cleaning liquid is for use in brushing the teeth 100. The pipe 20 is in communication with liquid pump 10 and U-shaped main body 30. The cleaning liquid provided by the liquid pump 10 is introduced into the U-shaped main body 30 with the pipe 20. The pipe 20 is a soft pipe made of biodegradable plastic. The biodegradable plastic is made from a biodegradable material, such as starch, polylactide and fibrous protein. Therefore, the pipe 20 is biodegradable and thus environment-friendly.

In an embodiment of the present disclosure, the U-shaped main body 30 includes a teeth-containing groove 31, a liquid inlet 32 and a liquid outlet 33. The teeth-containing groove 31 is U-shaped. The teeth-containing groove 31 corresponds in shape to dental arches so as to contain the plurality of teeth 100. The liquid inlet 32 is disposed at one end of the U-shaped teeth-containing groove 31. The liquid inlet 32 is in communication with pipe 20, so as to admit the cleaning liquid, allowing the cleaning liquid to flow within the teeth-containing groove 31. The liquid outlet 33 is disposed at the other end of the U-shaped teeth-containing groove 31 and is opposite the liquid inlet 32. The cleaning liquid in the teeth-containing groove 31 is discharged from the liquid outlet 33. However, the position of liquid inlet 32 is not limited to one end of the U-shaped teeth-containing groove 31. In a variant embodiment, the liquid inlet 32 is disposed at any position on teeth-containing groove 31, such as the arcuate bottom of the U-shaped teeth-containing groove 31. The U-shaped main body 30 is made of biodegradable plastic, and the biodegradable plastic is made from starch, polylactide and fibrous protein. Therefore, U-shaped main body 30 is not only biodegradable and thus environment-friendly but also disposable, so as to optimize patients' oral hygiene and prevent periodontitis, gingivitis, cellulitis, endocarditis and dementia.

In an embodiment of the present disclosure, the vibrating element 40 is a micro ultrasonic vibration motor and is connected to the U-shaped main body 30. The vibrating element 40 vibrates the U-shaped main body 30, such that the cleaning liquid flowing within the teeth-containing groove 31 vibrates, thereby enhancing teeth cleaning efficiency. The vibrating element 40 includes a switch 41. The ultrasonic vibration function of ultrasonic vibrating element 40 is activated with the switch 41. The vibrating element 40 provides ultrasonic vibration for removing tartars and plaque and enabling the cleaning liquid to wash away the tartars and plaque, so as to reduce the chance that the caretakers may be bitten by patients while on duty.

To clean the teeth 100 of a person confined to bed (such as an old person or patient who is disabled and confined to bed) with the disposable smart electronic teeth cleaning device 1 provided in an embodiment of the present disclosure, a caretaker fits the teeth-containing groove 31 of U-shaped main body 30 to the teeth 100 of the upper or lower jaw of the person confined to bed and put the part of pipe 20, which includes liquid inlet 32, in the oral cavity of the person confined to bed. Then, the caretaker can start the liquid pump 10 to enable the liquid pump 10 to provide the cleaning liquid. The cleaning liquid flows into the teeth-containing groove 31 via the pipe 20 and the liquid inlet 32, and flows along the teeth-containing groove 31, so as to dean the plurality of teeth 100 in the teeth-containing groove 31. Furthermore, the caretaker may press the switch 41 to activate the vibration function of the vibrating element 40, such that the vibration of the vibrating element 40 causes the vibration of the cleaning liquid flowing within the teeth-containing groove 31, so as to enhance teeth cleaning efficiency. Finally, the cleaning liquid which has finished cleaning the teeth 100 is discharged from the liquid outlet 33 and then delivered to the oral cavity of the person confined to bed. At this point in time, the caretaker can withdraw the cleaning liquid from the oral cavity of the person confined to bed with a conventional liquid extractor (not shown in the figure), so as to dean the teeth 100 of the person confined to bed conveniently.

Both the pipe 20 and the U-shaped main body 30 are placed in the oral cavity of the person confined to bed. Therefore, after cleaning the teeth 100 of the person confined to bed, the caretaker separates the pipe 20 and the liquid pump 10, and discards the pipe 20 and the U-shaped main body 30, so as to not only maintain good oral hygiene of the person confined to bed but also preclude repeated use of the pipe 20 and the U-shaped main body 30. With both the pipe 20 and the U-shaped main body 30 being made of biodegradable plastic, both the pipe 20 and the U-shaped main body 30 are biodegradable when discarded and thereby are environment-friendly.

The disposable smart electronic teeth cleaning device 1 provided in an embodiment of the present disclosure spares the caretaker the need to insert her/his hands deep into the oral cavity of the person confined to bed with a view to cleaning the teeth of the person confined to bed easily and safely, and thus the caretaker's hands are unlikely to be bitten by the person confined to bed. Furthermore, the disposable smart electronic teeth cleaning device 1 is capable of ultrasonic vibration and thereby can further enhance teeth cleaning efficiency. Both the pipe and the U-shaped main body of the disposable smart electronic teeth cleaning device 1 are made of biodegradable plastic and are thus biodegradable and environment-friendly.

What is claimed is:

1. A disposable smart electronic teeth cleaning device, for cleaning a plurality of teeth, the disposable smart electronic teeth cleaning device comprising:
a liquid pump for providing a cleaning liquid;
a pipe in communication with the liquid pump;
an U-shaped main body comprising:
a teeth-containing groove for containing the plurality of teeth; and
a liquid inlet disposed at the teeth-containing groove and in communication with the pipe,
wherein the cleaning liquid provided by the liquid pump flows into the teeth-containing groove via the pipe and the liquid inlet to clean the plurality of teeth in the teeth-containing groove.

2. The disposable smart electronic teeth cleaning device of claim 1, further comprising a vibrating element connected to the U-shaped main body.

3. The disposable smart electronic teeth cleaning device of claim 2, wherein the teeth-containing groove is U-shaped, and the liquid inlet is disposed at an end of the teeth-containing groove.

4. The disposable smart electronic teeth cleaning device of claim 3, wherein the U-shaped main body further comprises a liquid outlet disposed at another end of the teeth-containing groove and opposite the liquid inlet.

5. The disposable smart electronic teeth cleaning device of claim 4, wherein the pipe is made of biodegradable plastic.

6. The disposable smart electronic teeth cleaning device of claim 5, wherein the U-shaped main body is made of biodegradable plastic.
